(19) United States
(12) Patent Application Publication
(10) Pub. No.: US 2007/0255551 A1
(43) Pub. Date: Nov. 1, 2007

(54) Language reinforcement system

(76) Inventor: Edward Ma, Concord (CA)

Correspondence Address: LAW OFFICE OF MAI VU PARE, 9107 WILSHIRE BLVD. #450, BEVERLY HILLS, CA, 90210, US

(21) Appl. No.: 11/411,533

(22) Filed: Apr. 26, 2006

(51) Int. Cl. G06F 17/20

(52) U.S. Cl. 704/8

(57) ABSTRACT

A language reinforcement system comprising of one or more cups. Each cup comprises of markings. Said markings comprise at least one foreign word, a translation of said word(s), and a graphical illustration of said foreign word(s).

### FIELD OF THE INVENTION

The present invention relates to a language-reinforcement system. In particular, the present invention teaches a method of reinforcement the memorization of foreign words through the use of drinking cups.

### BACKGROUND OF INVENTION AND SUMMARY OF THE INVENTION

The conventional method of learning foreign languages is by memorization, understanding grammatical structure, listening to pronunciation, and in some cases learning a different alphabet. Oftentimes this takes place in a rigid, classroom setting by an instructor who may be a native of a country that speaks the language of interest.

The learning of a foreign language is complex and requires that the student possess many different skills for success. Excellent listening comprehension is required, especially for tonal languages for which intonations affect the meaning of a word. Analytical skills are required to understand grammatical structure and rules and memorization skills are essential.

The Chinese language is especially complex for a student whose first language is a western language. The Chinese language does not use the Roman alphabet, but rather Chinese characters represent different Chinese words and expressions. There are thousands of different Chinese characters. Students of the Chinese language may be required to learn 1) a Chinese character, 2) the phonetic translation of the Chinese character, and 3) a translation of the meaning of the Chinese character into the reference language. Chinese characters are further divided into two different sets. An orthodox character set that has been used in China for thousands of years; and in more recent history, the People's Republic of China put into place a program to simplify the orthodox system, creating a second set of characters.

With all of the different mental processes taking place while learning a foreign language, a student can become overwhelmed and avoid language studies once having left the classroom. Reinforcement of language lessons learned in a classroom however is critical if one is to master a language. Frequent review of vocabulary is necessary to build conversation skills and incorporate words into memory. Because the classroom setting may be tiring for a student, the student may not be motivated to study the language and review vocabulary outside of the class.

Attempts have been made to reinforce language studies through more fun and convenient methods. Flash cards are a common prior art method of learning a foreign language. Flash cards may be created by printing a foreign word on one side of a card with a translation of the foreign word on the other side. U.S. Pat. No. 5,525,060 titled “Multiple Language Learning Aid” teaches a modified flash card system in which 8 different faces of a card are held together in a single unit. The patent is well suited for the study of the Chinese language because of the numerous elements of the language required for learning. The numerous elements of the Chinese language may be displayed on one of the 8 different faces of the card unit. This system, however, requires discipline and focused concentration for success. If a student is already tired of language studies, he will be less inclined to put a complicated flash card system into use.

Casual exposure to a language on the other hand may be an excellent method to reinforce a foreign language because the user does not have the impression he is “working”. For this reason, immersion programs, where the student is constantly exposed to a foreign language through a cultural environment, are often successful. Students do not have the impression they are in a classroom setting and learn words and conversation skills in a casual, real life setting. Students may be more receptive to learning in this manner because they may be more relaxed and not confined to a classroom setting.

The present invention attempts to capture the success of relaxed learning environments by exposure of a foreign language in an every day object. While the present invention is not intended to act as a primary mode of learning a language, it may be used to reinforce vocabulary. The present invention relates to a series of drinking cups illustrated with foreign words, a translation of the foreign word, and a graphical illustration of the word of interest. Multiple embodiments may be provided in which a translation of a word may be provided adjacent to the foreign word, or it may provided on the bottom of the cup, so that a user can test his memory. The user may observe the words and translations while consuming a beverage. Thus a casual environment is provided in which a student can reinforce his memory of a foreign language while having a drink.

### DESCRIPTION OF DRAWINGS

FIG. 1 shows a planar side view of a cup.

FIG. 2 shows a planar side view of the cup shown in FIG. 1.

FIG. 3 shows a perspective view of an alternative embodiment of the cup.

### DETAILED DESCRIPTION OF PREFERRED EMBODIMENT

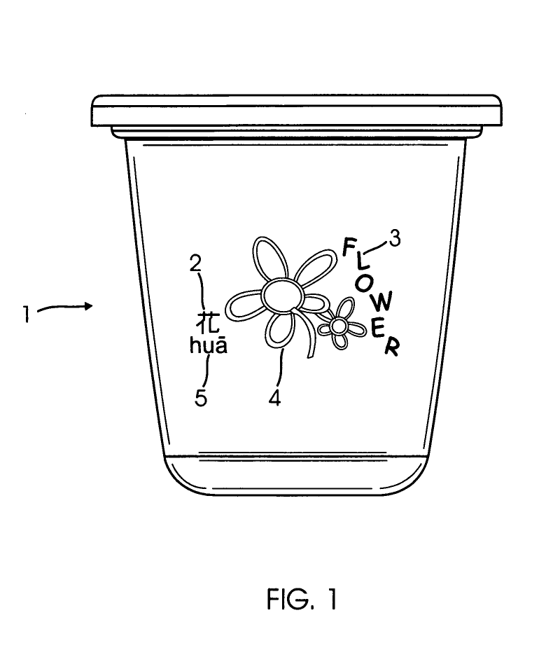

FIG. 1 depicts a planar view of one side of a cup 1. The cup has a cylindrical shape and comprises markings. The markings comprise a foreign word or character 2, a translation of the word 3, and a graphical illustration 4 of the word. In its preferred embodiment, the present invention is geared at the learning of the Chinese language. The markings in the preferred embodiment further comprise a phonetic translation 5 of a Chinese character in the roman alphabet.

The cup shown in FIG. 1 depicts the markings discussed above. The Chinese character for the word “flower” 2 is provided. Because students from western countries may not be familiar with Chinese characters, a phonetic translation of “flower” is also shown below the Chinese character as “hua” 5. A graphical illustration of a flower 4 is provided, for visual reinforcement of the language and the word “flower” 3 is provided in English.

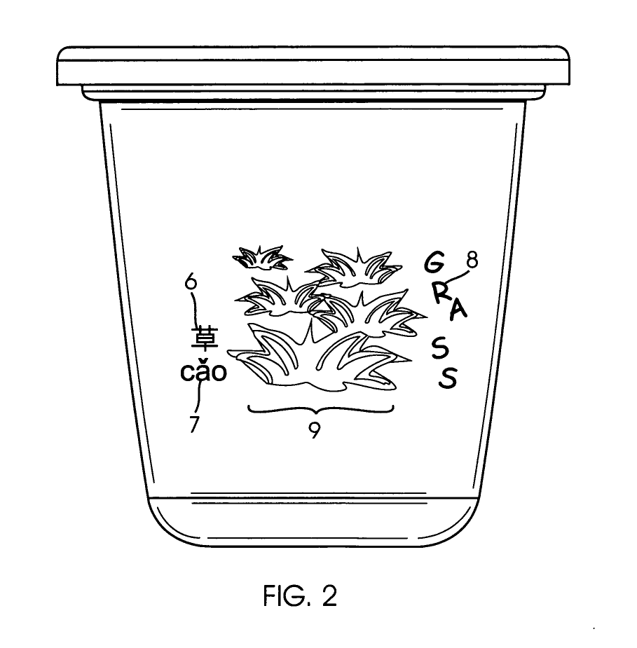

FIG. 2 shows a separate view of the cup shown in FIG. 1. The view shows markings depicting a Chinese character for the word “grass” 6. The word “cao” 7 is a phonetic translation for the character “grass”. An English translation for grass 8 is shown, as well as a graphical illustration 9.

In the preferred embodiment, the user is exposed to two different Chinese words, along with their graphical illustration and translation in a single cup. This provides the user with exposure to two words while he is using the cup. A person skilled in the art however may chose to include additional Chinese words and their translations or just one Chinese word and their translation.

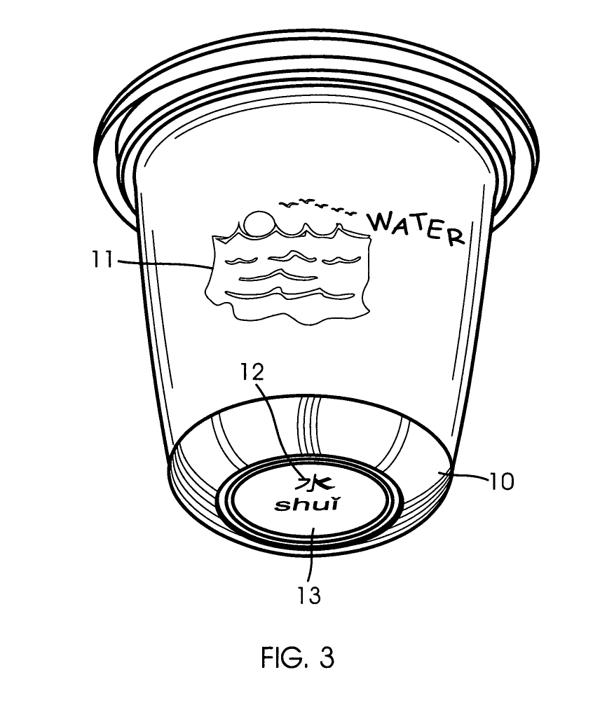

FIG. 3 shows an alternative embodiment of the present invention whereby the Chinese character 12 and phonetic translation 13 for “water” is provided on the bottom of the cup 10. The user may view the graphical illustration and English word for “water” on the side of the cup 11. When the user wishes to test his knowledge of the Chinese word for “water”, he may view the bottom of the cup only after testing his memory for the Chinese word for “water”.

Variations of the alternative embodiment may exist, where the translated word may be placed on the bottom of the cup and the Chinese character may be displayed on the side of the cup; or the phonetic translation of the word is placed by itself on the bottom of the cup and the English word and Chinese character is placed on separate sides of the cup. Different combinations may be provided within a set of cups so that the user is continually challenged.

In a preferred embodiment of the invention, the cups are constructed from materials such as wax-lined paper or disposable plastic. The cups may be constructed from recyclable materials as well. Multiple cups may be provided in a set so that the user is exposed to thousands of different words, along with their translations, and graphical illustrations. The sets may be categorized by theme or subject matter. For example, a set may be organized according to vocabulary relating to cooking. Or another set may be organized according to vocabulary relating to nature.

The cup may adequately hold only a small volume of liquid, such as 10 ounces or less. Furthermore, the cup may be constructed from material with a limited lifespan so that the cups lose their form with repeated storage of fluid. Because of these qualities, the typical user may use several cups throughout the course of a day. This exposes the user to several words or more a day without giving the user the impression that he is studying.

In summary, the present invention is a novel, inventive language teaching method that addresses many of the shortcomings in the art. With respect to the above description, it is to be realized that the optimum dimensional relationships for the parts of the invention, to include variations in size, materials, shape, form, function, manner and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, while still falling within the scope of the invention.

1. A language reinforcement system comprising:
one or more cups;
each cup comprises of markings;
said markings comprise at least one foreign word, a translation of said word(s), and a graphical illustration of said foreign word(s).

2. Said language-reinforcement system of claim 1 wherein the foreign word is in a dialect of the Chinese language.

3. Said language-reinforcement system of claim 2 wherein a marking of a Chinese character representing the foreign word is marked on the cup(s).

4. Said language-reinforcement system of claim 1 whereby said cup(s) are constructed from waxed paper.

5. Said language-reinforcement system of claim 1 whereby said cup(s) are constructed from plastic.

6. Said language-reinforcement system of claim 1 whereby said cup(s) are cylindrical in structure.

7. A language reinforcement system comprising:
one or more cups;
each cup comprises markings;
a side portion of said cup will comprise a marking in the form of a foreign word;
and a bottom portion of said cup will comprise a marking in the form of an English translation of said foreign word.

8. A language reinforcement system comprising:
one or more cups;
each cup comprises markings;
a side portion of said cup will comprise a marking in the form of an English word; and
a bottom portion of said cup will comprise a marking in the form of a foreign word corresponding to said English word.

9. The language reinforcement system of claim 1 wherein said multiple cups are organized in a set according to a theme.
